(19) United States
(12) Patent Application Publication
(10) Pub. No.: US 2007/0171199 A1
(43) Pub. Date: Jul. 26, 2007

(54) Locomotion simulation apparatus, system and method

(76) Inventor: Clement Gosselin, Sillery (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/707,086

(22) Filed: Feb. 16, 2007

Related U.S. Application Data
(63) Continuation-in-part of application No. PCT/CA05/01219, filed on Aug. 5, 2005.

(51) Int. Cl. G09G 5/00

(52) U.S. Cl. 345/156

(57) ABSTRACT

A motion simulation system for providing force feedback to a user in response to movement of the user within a virtual environment comprises a virtual environment system for producing a virtual environment to the user. Cables are connected to a user interface to support the user interface in a suspended position. Actuators are associated to each cable to adjust the length of the cables. A cable tension controller is connected to the actuators and to the virtual environment system to calculate a position and orientation of the user within the virtual environment as a function of the length of the cables, and to control the actuators so as to constrain movement of the user interface as a function of interactions between the user and the virtual environment, to provide force feedback to the user. A locomotion simulation apparatus and method are provide as well.

### CROSS-REFERENCE TO RELATED APPLICATION

This patent application is a continuation-in-part of International Patent Application No. PCT/CA2005/001219, bearing an international filing date of Aug. 5, 2005. This patent application claims priority on U.S. Provisional Patent Application No. 60/602,857, filed on Aug. 20, 2004, by the present Applicant.

### BACKGROUND OF THE INVENTION

1. Field of the Invention

The present invention is in the field of simulation, human rehabilitation, training, and exercise equipment, and relates to a virtual simulation method and apparatus that enable a user to perform natural locomotion/motions such as walking, running, or climbing on any virtual terrain that is computer displayed to the user.

2. Description of the Prior Art

One of the major problems in virtual simulation concerns the natural locomotion over large-scale virtual terrains. When only a small physical space is available, a mechanism must be provided to enable the user to travel naturally over large distances in the virtual environment without going far in the physical space. Such mechanisms are called locomotion simulation devices.

Thus, in general terms, the main purpose of a locomotion simulation device is to cancel the user's body motion so that the user's body remains confined within a small physical space (such as a frame) in the actual real world while the user makes exactly the same natural locomotion (e.g., walking, running, or climbing) as if traveling along an arbitrary virtual terrain. A good locomotion simulation device should be undetectable by (transparent to) the user in order for the latter to be substantially submerged in the virtual environment.

Locomotion simulation devices are used by the military to train combat soldiers in hostile environments that would be too dangerous and too expensive to reproduce in real. Locomotion simulation devices are also used by rehabilitation centers to practice and evaluate patients with locomotor problems. Locomotion simulation devices are also used by the entertainment industry as well as by fitness centers.

One of the approaches towards building a locomotion system is the use of a treadmill-style device. Current practical implementations range from the traditional treadmill found in every fitness center to more sophisticated treadmills with variable slopes, walking surface, and direction.

One of the relatively simpler linear treadmills is the Treadport Locomotion Interface developed by the U.S. Sarcos Group. In its latest version, [e.g., presented in the publication “Design Specifications for the Second Generation Sarcos Treadport Locomotion Interface” by J. M. Hollerbach, Y. Xu, R. Christensen, and S. C. Jacobsen (2000)], the Treadport consists of a 6 by 10 ft flat walking surface that can be inclined to up to about 20 degrees. An active mechanical tether is attached to the user through a harness to simulate the effects of inertia (during acceleration), unilateral constraints (such as running into a wall), or slopes, and measure the user's position and orientation (pose). The whole system is placed in front of a CAVE-like visual display.

A different linear treadmill simulation device is the GSS (Ground Surface Simulator) developed by the ATR Communication System Laboratory in Japan, and presented in the publication “Development of Ground Surface Simulator for Tel-E-Merge System” by H. Noma, T. Sugihara, and T. Miyasato (2000). The GSS consists of a modified linear treadmill in which six roller-sections move up and down beneath the belt surface to create the effect of an uneven terrain such as small bumps or slope.

A disadvantage of the above two devices is the inability to simulate—or rather cancel—a change in the direction of travel. Accordingly, a user of such device is limited to moving in one direction to stay confined to the system. One simple solution sacrificing the ability to simulate slopes is to implement a large sphere on the surface of which the user can walk and run. One such device is the Cybersphere developed by VR Systems, and is presented in the publication “Cybersphere: The Fully Immersive Spherical Projection System” by K. J. Fernandes, V. Raja, and J. Eyre (2003). The Cybersphere consists of a hollow sphere of 11.5 ft in diameter, made from two layers of thirty semi-transparent segments and supported by a low-pressure air cushion. The user enters the sphere through a hatch and causes the sphere to rotate through natural walking or running. Images of the virtual environment are projected onto segments of the outer surface of the sphere by five projectors. The Cybersphere is very much similar to the invention disclosed in U.S. Pat. No. 6,563,489 (granted to Latypov et al. on May 13, 2003) and also resembles the invention disclosed in U.S. Pat. No. 6,135,928 (granted to Butterfield on Oct. 24, 2000) in which the user walks on the outer side of a sphere while being suspended from the above.

Another type of locomotion simulation device preserving the ability to simulate variable slopes would be an omni-directional treadmill. One such invention, called the Omni-Directional Treadmill (ODT), is disclosed in U.S. Pat. No. 6,152,854 (granted to Carmein on Nov. 28, 2000) and discussed in the publication “The Omni-Directional Treadmill: A Locomotion Device for Virtual Worlds” by R. P. Darken, W. R. Cockayne, and D. Carmein (1997). The ODT, commercialized by U.S. Virtual Space Devices, consists of two perpendicular treadmills, one inside the other. The top belt, comprising an array of freely rotating rollers, lies over another orthogonally oriented belt, also composed of rollers. Each belt is made of about 3400 separate rollers. A similar omni-directional treadmill, called the Torus Treadmill, was built at the University of Tsukuba and presented in the publication “The Torus Treadmill: Realizing Locomotion in VEs” by H. Iwata (1999). The Torus Treadmill consists of a large treadmill, on the belt of which 12 sets of narrow treadmills are mounted perpendicularly. In both cases, the devices could be mounted on a motion platform in order to enable the simulation of variable slopes. These devices are, however, mechanically complex.

Besides from being mechanically complex, the treadmill-style devices can simulate only simple locomotion (walking or running) on a relatively flat and rigid surface. Thus, they cannot simulate locomotion on an arbitrary terrain such as stairs, the edge of a thin wall, or mud. Furthermore, on a treadmill-style device, the location of the user's feet is unknown, unless additional measurement devices are utilized, as proposed in U.S. Pat. No. 5,577,981 (granted to Jarvik on Nov. 26, 1996). Thus, the system has to “guess” where the user intends to step down. It is only in the Cybersphere that this problem is solved naturally in a passive way since gravity automatically forces the sphere to rotate and the user to regain the central position.

A different style of locomotion simulation devices allows to overcome the disadvantages of treadmill-style systems. This different style is based on the use of two separate footplates whose position and orientation are independently controlled through robotic devices.

A locomotion simulator based on programmable footplates is described in U.S. Pat. No. 5,490,784 (issued to Carmein on Feb. 13, 1996). In that patent, a spherical capsule mounted on a parallel robotic system (a so-called hexapod) includes, in one of the numerous embodiments, two footplate mechanisms of undisclosed architecture.

One of the earliest specific programmable footplates is the invention disclosed in U.S. Pat. No. 5,580,249 (granted to Jacobsen et al. on Dec. 3, 1996) and developed by the U.S. Sarcos Group, under the name Biport. The Sarcos Biport consists of two mechanical robotic devices mounted on a common frame and each having three degrees of freedom controlled by three motors. The user's feet are individually attached to each robotic device. The motors provide resistance to the user's locomotion in correspondence to the simulated virtual environment.

A similar system was disclosed in U.S. Pat. No. 5,872,438 (issued to Roston on Feb. 16, 1999) in which each footplate is fixed on a three-degree-of-freedom mechanical parallel robotic system with motorized rails fixed to the base. The footplates can either stay in permanent contact with the user's feet or lose contact when the user lifts a foot in the air.

Another such locomotion simulator is disclosed in U.S. Pat. No. 5,902,214 (granted to Makikawa et al. on May 11, 1999) and U.S. Pat. No. 6,102,832 (granted to Tani on Aug. 15, 2000), where the footplate mechanisms are either of several types of multi-degree-of-freedom mechanical robotic devices.

A further device with programmable footplates to be used for rehabilitation purposes is disclosed in U.S. Pat. No. 6,162,189 (issued to Girone et al. on Dec. 19, 2000), where the feet of the user are placed on hexapods. However, the device is used purely for balance exercises.

Iwata and his team at the University of Tsukuba, Japan, have also built another such locomotion simulator called the Gait Master, discussed in the publication “Gait Master: A Versatile Locomotion Interface for Uneven Virtual Terrain” by H. Iwata, H. Yano, and F. Nakaizumi (2001). The Gait Master consists of two three-degree-of-freedom parallel robotic devices with individual footplates. The two devices are mounted on a rotary stage to allow the simulation of walking in any direction. The user's feet lose contact with the footplates during walking and a simple string sensor tripod system is used for each foot to detect its position so that the footplate can follow the foot.

Finally, a robotic walking simulator is presented in the publication “Design of a Robotic Walking Simulator for Neurological Rehabilitation” by H. Schmidt, D. Sorowka, S. Hesse, and R. Bernhardt (2002). The simulator comprises two mechanical three-degree-of-freedom robots moving each foot in the sagittal plate (i.e., the user can walk only in one direction).

The above-mentioned programmable footplates are based on the use of complex mechanical robotic systems. Such systems tend to be bulky, noisy, costly, and unsafe. Furthermore, as these robotic systems are placed very near to each other, they limit the range of motion of the simulator due to the risk of interference.

A way of reducing the number of mechanical parts in a robotic system is the use of cables. The use of cables reduces the cost of the system and allows for an increase in the mobility of the system. Cable robotic systems have been used in various fields to displace objects. Such systems are convenient in that relatively small actuation is required to displace such objects.

For instance, one such cable robotic system, used in the broadcast of various sporting events, is a camera suspension system, disclosed in U.S. Pat. No. 4,625,938 (issued to Brown on Dec. 2, 1986), that consists of a camera suspended in the air by four variable-length cables. Another cable robotic system, used for space applications and disclosed in U.S. Pat. No. 5,585,707 (granted to Thompson et al. on Dec. 17, 1996), consists of a platform suspended in the air by eight variable-length cables. Another cable robotic system, used as a crane and disclosed in U.S. Pat. No. 6,566,834 (granted to Albus et al. on May 20, 2003), consists of a manipulator platform suspended in the air by a plurality of variable-length cables. Another cable robotic system, used as a three-dimensional haptic device and disclosed in U.S. Pat. No. 6,630,923 (issued to Sato on Oct. 7, 2003), comprises a grip connected to a base via at least seven variable-length cables. A cable system used as an exercise equipment, disclosed in U.S. Pat. No. 6,280,361 (granted to Harvey et al. Aug. 28, 2001), comprises a bar connected to the base via a plurality of variable-length cables.

A locomotion simulation device has used cables, as means of actuation, namely the one presented in the publication entitled “STRING-MAN: A New Wire Robot for Gait Rehabilitation” by D. Surdilovic and R. Bernhardt. The STRING-MAN is essentially a system of cables attached to the body of a user through a harness. Through varying the length of the cables, the pose of the user's trunk is defined. The user is, however, walking on a simple conventional linear treadmill.

In all of the above-mentioned systems, the length of or the tension in each cable is individually controlled by a motor with a reel about which the cable is wound. The system is thus controlled in position and/or force.

It is desired to increase the use of cables within cable robotic systems, such as locomotion simulation devices, to improve the mobility of such devices while benefiting from the advantages of cable actuation.

### SUMMARY OF INVENTION

It is an object of the present invention to provide a novel locomotion simulation apparatus and system.

It is an object of the present invention to provide a locomotion simulation apparatus and system which substantially overcome the disadvantages of the prior art.

It is a still further object of the present invention to provide a method for providing force feedback to a user of a virtual environment system.

In view of the foregoing, it is an objective of the present invention to provide versatile, low-cost, and safe human locomotion virtual simulation method and apparatus that enable a user to experience a full range of locomotion such as walking, running, or climbing, on any arbitrary virtual terrain while being confined within a relatively small physical space.

Therefore, in accordance with the present invention, there is provided a locomotion simulation apparatus for providing force feedback to a user in response to movement of the user, comprising: two foot supports, each foot support being adapted to support a foot of a user; cables connected to the foot supports, so as to support each of the two foot supports independently from one another in a suspended position; and an actuator for each of the cables, each of the actuators being mounted to a frame, and being connected to an associated one of the cables so as to control the length of the associated one of the cables to constrain movement of the foot supports such that the user moves in a selected motion.

Further in accordance with the present invention, there is provided a motion simulation system for providing force feedback to a user in response to movement of the user within a virtual environment, comprising: a virtual environment system for producing a virtual environment to the user; a user interface; cables connected to the user interface to support the user interface in a suspended position; actuators associated to each cable to adjust the length of the cables; and a cable tension controller connected to the actuators and to the virtual environment system to calculate a position and orientation of the user within the virtual environment as a function of the length of the cables, and to control the actuators so as to constrain movement of the user interface as a function of interactions between the user and the virtual environment, to provide force feedback to the user.

Still further in accordance with the present invention, there is provided a method for providing force feedback as a function of a virtual environment to a moving user provided with a user interface constrained by cables of adjustable length, comprising the steps of: i) determining a position and orientation of the user interface; ii) comparing the position and orientation of the user interface with respect to a virtual environment to determine interactions therebetween; and iii) adjusting a length of the cables to provide force feedback to the user as a function of said interactions.

Still further in accordance with the present invention, there is provided a human locomotion virtual simulation apparatus, comprising two footplates attached independently to each foot of a user and each said footplate connected to a fixed frame by a plurality of cables driven by actuators, so that the position and orientation of said footplates can be controlled independently and each said foot can be shifted individually horizontally forward, backward, leftward, rightward, as well as up and down and can also be slanted and twisted in all directions, by adjusting the length of the cables; and a control device for adjusting the length or the tension of said cables in order to produce required displacements or forces at each of said user's feet.

The above and other objectives of this invention are realized in a specific illustrative embodiment of an apparatus for simulating the mobility of a human user. The apparatus includes two footplates, on which the user's feet are strapped separately, a body harness, and possibly two handles, on which a user's hands are placed separately, each of footplates, handles, and harness, independently connected to a common frame through a plurality of variable-length cables. Each cable is wound about a motorized reel fixed at a frame. The motors are equipped with encoders so that the length of each cable is known at any moment. The poses of the footplates, handles, and harness are calculated at any moment through the implementation of a forward kinematic algorithm. Furthermore, the footplates and the handles may be equipped with 6-axis force sensors. The motors set the length of the cables or the forces in the cables. A computer system containing the model of a virtual environment compares the pose of the footplates, handles, and harness with the elements of the virtual environment that would come into contact with the user's body, had the user been actually present in the virtual environment, and sends control commands to the motors. The virtual environment is presented to the user through a head-mounted display.

### BRIEF DESCRIPTION OF THE DRAWINGS

A preferred embodiment of the present invention will now be described with reference to the accompanying drawings in which:

FIG. 1 is a schematic view of a locomotion simulation apparatus in accordance with a preferred embodiment of the present invention;

FIG. 2 is a block diagram illustrating a motion simulation system controlling the locomotion simulation apparatus of FIG. 1;

FIG. 3 is a perspective view of a cable configuration for a single footplate of the locomotion simulation apparatus of FIG. 1, in accordance with one embodiment;

FIG. 4 is a perspective view of a cable configuration for a single footplate of the locomotion simulation apparatus of FIG. 1, in accordance with another embodiment; and

FIG. 5 is a schematic view of a motion simulation apparatus in accordance with another embodiment, as used as a sword.

### DESCRIPTION OF THE PREFERRED EMBODIMENTS

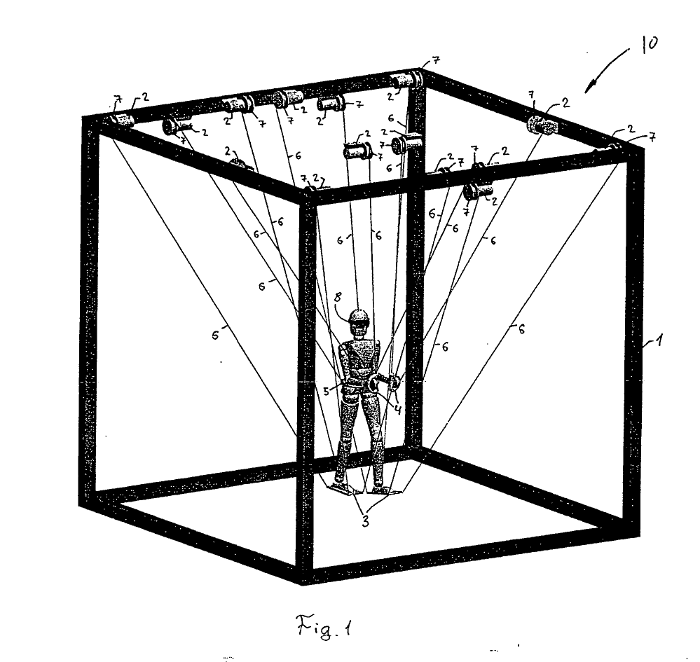

Referring to the drawings and, more particularly, to FIG. 1, a locomotion simulation apparatus is generally shown at 20, as being used by a user person A. The apparatus 10 has a frame 1, that is provided to support cables 6 that will actuate the interfaces between the apparatus 10 and the user person A, namely the footplates 3, the handles 4 and the body harness 5. The apparatus 10 has two footplates 3, upon which the user's feet are strapped separately. Handles 4, on which a user's hands are placed separately, and a body harness 5, are each independently connected to the frame 1 through a plurality of variable-length cables 6. Finally, the user wears a head-mounted display 8 with audio speakers.

Actuators 2 are fixed to the frame 1. Each actuator 2 has a reel 7, and each cable 6 is connected to a reel 7/actuator 2 assembly. The cables 6 are wound onto/unwound from the respective reels 7, whereby the cables 6 vary the distance between the frame 1 and the user interfaces.

For clarity purposes, the schematic view of FIG. 1 is a simplified representation of the locomotion simulation apparatus 10, in that a plurality of the variable-length cables 6 have been omitted. Contemplated configurations are described in detail hereinafter. For instance, in FIG. 1, all actuators 2 are fixed at the top of the frame 1, but it may be advantageous to place some of the actuators at various other locations on the frame. Similarly, the footplates 3 are shown as simple rectangular pads but they may be of more complex nature, such as boots, or may support connectors that will cooperate with complementary connectors on the user person's feet.

The handles 4 are also represented as simple rings but they may be more complex, such as joysticks, firearm models, or any handled object associated to the virtual environment. There may be two separate handles 4 as illustrated in FIG. 1, a single one, or none at all. The displacement of the handles 4 may be controlled so as to reproduce obstacles of the virtual environment. For example, the handles 4 may be used to simulate the climbing up a ladder. Additionally, in FIG. 1, the harness 5 is represented as a simple belt, but it may be a more sophisticated body harness.

Regardless of the shape of the footplates 3, six-axis force sensors may be placed on them to allow the determination of the reaction forces and moments between each foot of the user and the corresponding footplate 3. Similarly, regardless of the shape of the handles 4, six-axis force sensors may be placed on them to allow the determination of the reaction forces and moments between each of the user's hands and the corresponding handle 4. The interconnection between the interfaces, such as the footplates 3 and handles 4, and the associated cables are such that the interfaces are movable along 6 degrees-of-freedom, provided no restrictions are imposed by the reels 7 (e.g., as a function of the virtual environment).

The length of or the tension in each cable 6 is set by its corresponding actuator 2, which is controlled by a central controller in relation to the user's interaction with the virtual environment. In other words, the central controller controls the actuators 2 either in position mode, allowing the cables 6 to wind/unwind to follow the user person's displacements, or in force mode, constraining the winding/unwinding of the cables 6 to provide force feedback and to reproduce obstacles and/or elements of the virtual environment.

The actuators 2 can also be controlled using a hybrid controller in which all actuators 2 contribute to both force and position control in the Cartesian space of motion of the footplates 3 and other interfaces. In that case, some of the Cartesian degrees of freedom of the footplates 3 (X, Y, Z, psi, theta, phi) can be controlled in force while others are controlled in position, according to the properties of the virtual environment.

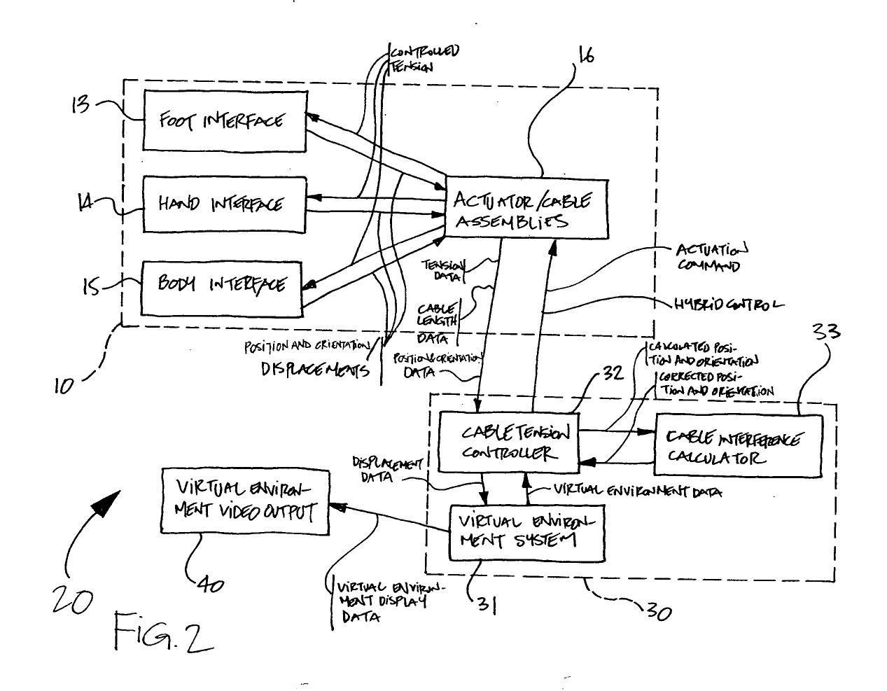

More specifically, referring to FIG. 2, a motion simulation system, which includes the locomotion simulation apparatus 10 or like motion simulation apparatus (as will be described hereafter), is generally shown at 10. The motion simulation system 20 has, in addition to the apparatus 10, a central controller 30, and a virtual environment video output 40.

The central controller 30 has a virtual environment system 31 that will generate a virtual environment. The virtual environment system 31 will output display data to the virtual environment video output 40. The video output 40 is represented in FIG. 1 as the head-mounted display 8 with audio speakers, and is provided to produce the virtual environment for the user person using the locomotion simulation apparatus 10. The video output 40 may also be video screens surrounding the locomotion simulation apparatus 10, so as to immerse the user of the locomotion simulation apparatus 10 in the virtual environment projected or output on the screen.

As mentioned previously, the apparatus 10 has user interfaces, illustrated in FIG. 2 as foot interface 13 (in FIG. 1 represented by the foot plates 3), hand interface 14 (in FIG. 1 represented by the handles 4), and body interface 15 (in FIG. 1 represented by the harness 5). The interfaces 13, 14 and 15 are each connected to actuator/cable assemblies 16, which are represented in FIG. 1 as the combination of the actuators 2, the cables 6 and the reels 7. A single interface, such as one of the foot plates 3 (FIG. 1), is typically supported by a plurality of the assemblies 16 (i.e., actuator 2/cable 6/reel 7 assembly of FIG. 1).

Using the information from the six-axis force sensors integrated in the interfaces 13, 14 and/or 15, or simply the information from the actuators 2 (FIG. 1) from which the length of and the tension in the cables 6 (FIG. 1) may be calculated, the central controller 30 is controlling the actuators 2 of the assemblies 16 so that the cables 6 are always in tension. In this way, the central controller 30 may determine the position and orientation of the interfaces 13, 14 and/or 15.

Therefore, as shown in FIG. 2, the actuator/cable assemblies 16 provide controlled tension to the interfaces 13, 14 and 15. This is achieved, in the apparatus 10 illustrated in FIG. 1, by the actuators 2 of the assemblies 16 (FIG. 2) actuating the reels 7, so as to adjust the level of tension in the cables 6 as a function of pressure exerted on the cable 6 by the user person A through the interface (e.g., footplate 3) and by gravity. Alternatively, if the interfaces 13, 14 and 15 are equipped with six-axis force sensors, the interfaces 13, 14 and 15 send position and orientation data to the assemblies 16.

In order to provide force feedback to the user person in relation to the elements and obstacles encountered in the virtual environment, the central controller 30 has a cable tension controller 32 that is connected to the virtual environment system 31. The cable tension controller 32 receives virtual environment data from the virtual environment system 31. The cable tension controller 32 is also connected to the actuator/cable assemblies 16, so as to receive position and orientation data from the assemblies 16, for instance in the form of the length of the cables 6 (FIG. 1), the tension detected by the actuators 2 (FIG. 1), whereby the cable tension controller 32 will calculate the position and orientation of the interfaces 13, 14 and 15. Alternatively, if sensors are used in the interfaces 13, 14 and 15, the cable tension controller 32 will receive position and orientation data, that is used to calculate the position and orientation of the interfaces 13, 14 and 15. The interfaces 13, 14 and 15 may be provided with sensors (e.g., magnetic sensors, optical sensors), that will enable the position and orientation data to be calculated, and related to the length of the cables for controlling the force feedback with the central controller 30.

As the cable tension controller 32 also receives virtual environment data from the virtual environment system 31, the cable tension controller 32 will relate the position and orientation of the interfaces 13, 14 and 15 to the virtual environment. For instance, if obstacles are met by the user person in the virtual environment following movements in the free space of the locomotion simulation apparatus 10, the cable tension controller 32 will output actuation commands to the actuator/cable assemblies so as to control the tension in the cables to simulate the feel of the obstacles to the user person in the locomotion simulation apparatus 10.

In order for the virtual environment system 31 to adjust the virtual environment to the displacements of the user person A in free space, the cable tension controller 32 outputs displacement data to the virtual environment system 31, the displacement data being produced by the cable tension controller 32 as a function of the position and orientation of the interfaces 13, 14 and 15 and of the virtual environment.

Thus, when the user's foot is lifted and starts moving in free space of the locomotion simulation apparatus 10, the assemblies 16 maintain the cables 6 (FIG. 1) associated with the corresponding foot interface 13 in tension, just enough for the cables 6 to be taut. As soon as the foot reaches a virtual hard surface within the virtual environment, the cables 6 connected to the corresponding footplate constrain the footplate to become immovable. As the cables are very stiff in tension, it is possible to simulate very sharp force changes such as stepping on a hard floor. Alternatively, if an elastic or viscous virtual surface is reached, such as mud, the actuators 2 (FIG. 1) of the actuator/cable assemblies 16 ensure that the reaction forces and moments between the foot and the footplate correspond to the reaction forces and moments that would occur if the user were stepping on the same elastic or viscous surface. The same simulation is reproduced for the handles.

As the user person A moves in the physical space, the actuator/cable assemblies 16 gradually pull back the user person A into the center of the frame 1 (FIG. 1) by the body interface 15, to ensure that the user person A remains confined to the volume of the locomotion simulation apparatus 10. Although the locomotion simulation apparatus 10 would provide a functional embodiment with only the foot interface 13, if only the foot interface 13 were provided (i.e., without the body interface 15), the shift of the foot plates 3 (FIG. 1) of the foot interface 13 to return the user person A to the central position within the frame 1 (FIG. 1) could cause the user person A to lose balance and fall down. The body interface 15 acts both as a safety device and as means for guiding.

Moreover, the body interface 15 (e.g., the body harness 5) is used to simulate the forces of inertia on the user person. More specifically, in order to enhance the effect of the virtual environment on the user person, it is contemplated to reproduce forces of inertia (in the form of force feedback) by adjusting the tension in the appropriate actuator/cable assemblies 16 associated with the body interface 15 as a function of the displacement of the user person in the virtual environment.

Naturally, while the user person A is moving, the cables 6 (FIG. 1) connected to the interfaces may interfere. Therefore, the central controller 30 has a cable interference calculator 33 related to the cable tension controller 32, that will determine the cable interferences, according to available information (e.g., length of interfering cables and non-interfering cables, position and orientation of interfaces 13, 14 and 15). For instance, if the length of the interfering cables and the position and orientation of the interfaces 13, 14 and/or 15 are known, the position of the intersection between interfering cables is geometrically calculable. Accordingly, an adjustment taking into account the interference between cables is calculated by the cable interference calculator 33, which adjustment is considered by the cable tension controller 32 in controlling the actuator/cable assemblies 16.

When a foot is lifted in the air, the cables 6 (FIG. 1) associated with the corresponding footplate 3 (FIG. 1) may come into interference with the cables 6 of the other footplate 3. Since the cables 6 (FIG. 1) associated with the foot in the air are subject to relatively small tension compared to the cables 6 associated with the foot on which the user has transferred its weight, the former cables will not perturb the latter and will simply elongate (i.e., increase in length) while still being taut. This elongation can be freely allowed by the assemblies 16 (FIG. 2) in the case of force control, whereby the cable interference calculator 33 will correct the position and orientation data of the cable tension controller 32. Alternatively, the elongation may be pre-calculated by the cable interference calculator 33 in the case of position control (with sensors on the interfaces providing force feedback information). The cable interference calculator 33 may also be used for the hand interface 14 as well as for combinations between any two interfaces in which one supports the user's weight while the other is not subject to any relatively large efforts.

Finally, as mentioned previously, the virtual environment video output 40 (e.g., the head-mounted display 8 of FIG. 1) shows images and optionally plays sounds in relation to the virtual environment in which the user travels. Thus, for example, if the user advances in a certain direction, the image advances in a relative direction, and if the user places a foot onto a hard surface, a footstep sound is played, through the combined action of the locomotion apparatus 10 and the central controller 30.

The above-described locomotion simulation apparatus 10, system 20 and method have a number of advantages over similar rigid-body motion simulation device. Firstly, the use of a cable system provides an inexpensive and effective way of building a motion simulation devices. The use of a cable system is also safer than the use of rigid-body foot platforms. Cables also exhibit virtually no limits on the operating range since they can be as long as needed without considerably deteriorating the dynamic performance of the motion simulation device (cables are very light). Thus, the locomotion simulation apparatus 10 may be reproduced to a large scale (e.g., in a large hangar in order to simulate a free fall of two meters). Also, cable systems, being relatively thin, reduce mechanical interferences to a minimum, and may be used with calculation systems, such as the cable interference calculator 33, that enable the cable system to operate even when the cables are in interference.

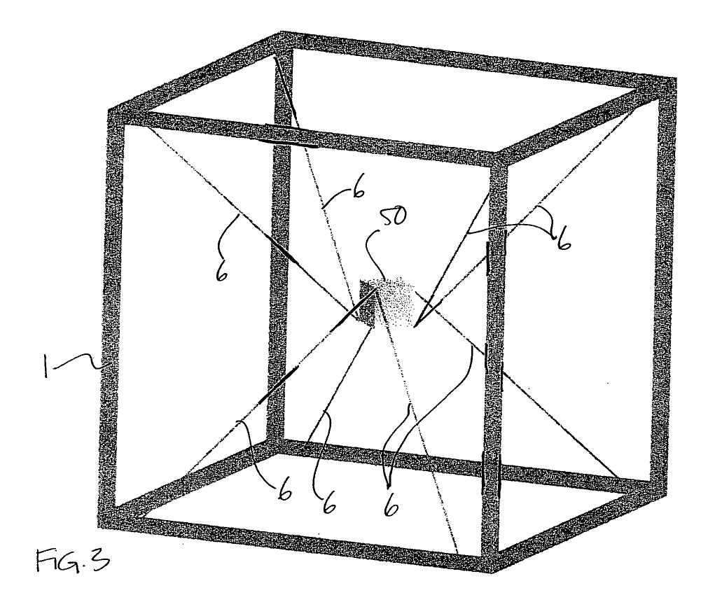

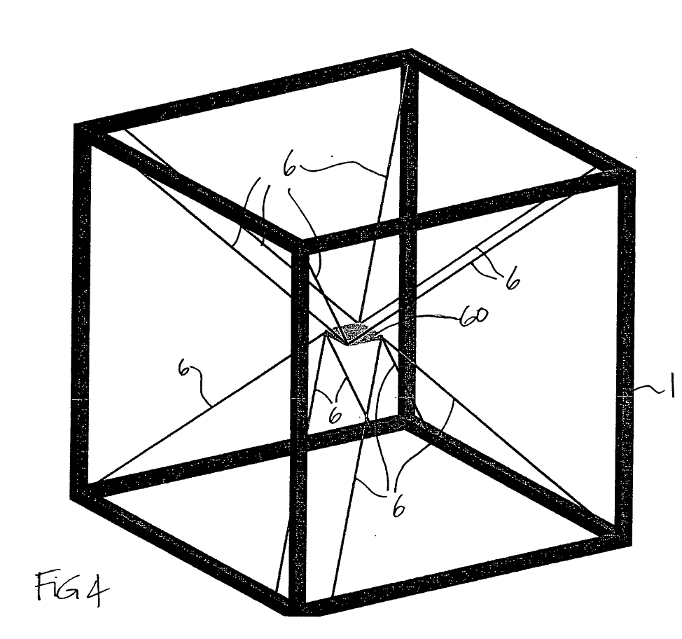

In order to control the footplates of foot interface 13 and the handles of the hand interface 14 to reproduce desired constraints related to the virtual environment, the cables of the actuator/cable assemblies 16 must be in predetermined positions with respect to the interfaces. As mentioned previously, the locomotion simulation apparatus 10 of FIG. 1 has been simplified in that a lesser amount of cables than required for functionality are illustrated, for clarity purposes. FIGS. 3 and 4, described hereinafter, are provided to illustrate non-restrictively two possible cable position configurations to obtain a functional embodiment.

Referring to FIG. 3, a generic interface (i.e., one of the foot supports or one of the handles) is illustrated at 50, as supported in the frame 1 by eight cables 6. For simplicity purposes, the cables 6 are schematically shown directly connected to the frame 1, although connected to the frame 1 by actuators 2/reels 7 in the locomotion simulation apparatus 10.

Referring to FIG. 4, another generic interface (i.e., one of the foot supports or one of the handles) is illustrated at 60, as supported in the frame 1 by twelve cables 6. Once more, for simplicity purposes, the cables 6 are schematically shown directly connected to the frame 1, although connected to the frame 1 by actuators 2/reels 7 in the locomotion simulation apparatus 10. It is pointed out that other cable position configurations are contemplated, with less or more cables.

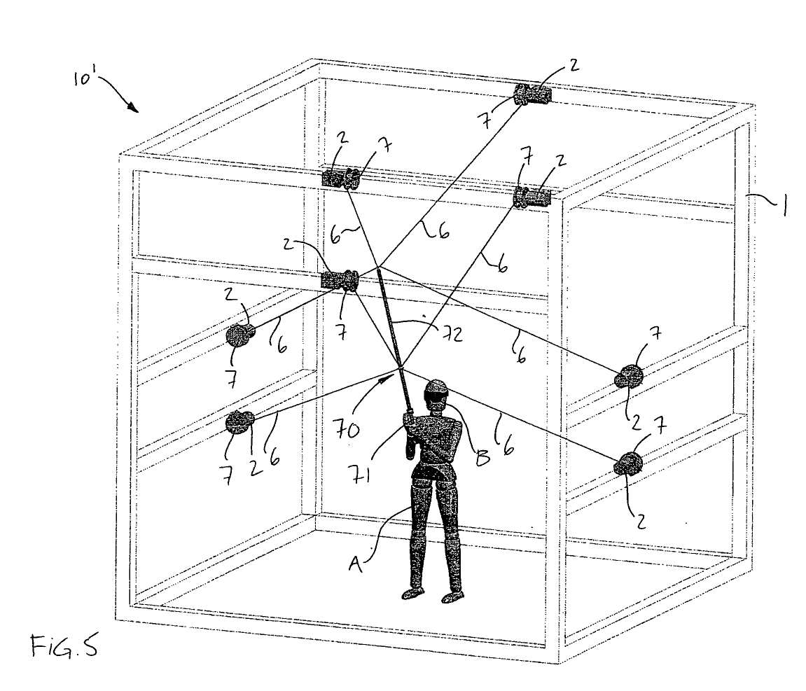

Referring to FIG. 5, the motion simulation apparatus is shown at 10′ in a sword simulator configuration. Like elements between the apparatuses 10 and 10′ bear like reference numerals. In the sword simulator configuration, the user interface is a sword 70 (or like weapon such as sabre, etc.) The sword 70 has a hand interface and a sword/blade portion 72.

The sword simulator configuration is typically used in video games, such that force feedback is simulated on the sword as a function of virtual action. The user is shown wearing a virtual reality viewer B. In order to provide suitable force feedback to the user (i.e., combination of position and force more), cables 6 are positioned at two locations on the blade portion 72. In FIG. 5, one of the locations is at a tip of the blade portion 72, whereas another location is adjacent to the hand interface.

A set of four cables is supplied at each of the locations, and each cable 6 is controlled by its own reel 7/actuator 2 assembly. The apparatus 10′ is part of the motion simulation system (FIG. 2), and may be used in an embodiment with foot interfaces (such as the one illustrated at 13 in FIG. 2), and a body interface (e.g., as illustrated at 15 in FIG. 2). It is suggested to provide 6-axis sensors in the sword 70 to ensure the efficiency of the force feedback.

### REFERENCES

1. Hollerbach, J. M., Xu, Y., Christensen, R., and Jacobsen, S. C., 2000, “Design specifications for the second generation Sarcos Treadport locomotion interface,” Proceedings of the Haptics Symposium, ASME Dynamic Systems and Control Division, DSC-Vol. 69-2, Orlando, November 5-10, pp. 1293-1298.
2. Noma, H., Sugihara, T., and Miyasato, T., 2000, “Development of Ground Surface Simulator for Tel-E-Merge System,” Proceedings of the IEEE Virtual Reality Conference, March 18-20, New Brunswick, N.J., pp. 217-224.
3. Fernandes, K. J., Raja, V., and Eyre, J., 2003, “Cybersphere: The Fully Immersive Spherical Projection System,” Communications of the ACM, September, Vol. 46, No. 9.
4. Darken, R. P., Cockayne, W. R., and Carmein, D., 1997, “The Omni-Directional Treadmill: A Locomotion Device for Virtual Worlds,” Proceedings of UIST, Banff, Canada, October 14-17 pp. 213-221.
5. Iwata, H., 1999, “The Torus Treadmill: Realizing Locomotion in VEs,” IEEE Journal of Computer Graphics and Applications, Vol. 19, No. 6, pp. 30-35.
6. Iwata, H., Yano, H., and Nakaizumi, F., 2001, “Gait Master: A Versatile Locomotion Interface for Uneven Virtual Terrain,” Proceedings of the IEEE Virtual Reality Conference, March 13-17, pp. 131-137.
7. Schmidt, H., Sorowka, D., Hesse, S., and Bernhardt, R., 2002, “Design of a Robotic Walking Simulator for Neurological Rehabilitation,” Proceedings of the 2002 IEEE/RSJ International Conference on Intelligent Robots and Systems, Lausanne, Switzerland, October.
8. Surdilovic, D., and Bernhardt, R., 2004, “STRING-MAN: A New Wire Robot for Gait Rehabilitation,” Proceedings of the 2004 International Conference on Robotics and Automation (ICRA), New Orleans, La., April 26-May 1.
9. http://www.vr-systems.ndtilda.co.uk/sphere1.htm
10. http://userpage.fu-berlin.de/˜hsch/HapticWalker/HapticWalker.html
11. http://intron.kz.tsukuba.ac.jp/vrlab web/gaitmaster/gaitmaster e.html
12. http://www.sarcos.com/interpic virtualinter.html
13. http://www.cgsd.com/OmniTrek.html

1. A locomotion simulation apparatus for providing force feedback to a user in response to movement of the user, comprising:
two foot supports, each foot support being adapted to support a foot of a user;
cables connected to the foot supports, so as to support each of the two foot supports independently from one another in a suspended position; and
an actuator for each of the cables, each of the actuators being mounted to a frame, and being connected to an associated one of the cables so as to control the length of the associated one of the cables to constrain movement of the foot supports such that the user moves in a selected motion.

2. The locomotion apparatus according to claim 1, further comprising a body harness connected to a trunk of the user, cables connected to the body harness, and actuators for relating each of the cables associated with the body harness to the frame so as to control a length of the cables associated with the body harness to maintain the user originally positioned with respect to the frame.

3. The locomotion apparatus according to claim 1, further comprising at least one hand interface handled by the user, cables connected to the hand interface, and actuators for relating each of the cables of the hand interface to the frame so as to control a length of the cables to constrain movement of the hand interface handled by the user.

4. The locomotion simulation apparatus according to claim 1, wherein the actuators control the tension in the cables during winding/unwinding of the cables as a function of movements of the user to provide a feedback sensation to the user.

5. A motion simulation system for providing force feedback to a user in response to movement of the user within a virtual environment, comprising:
a virtual environment system for producing a virtual environment to the user;
a user interface;
cables connected to the user interface to support the user interface in a suspended position;
actuators associated to each cable to adjust the length of the cables; and
a cable tension controller connected to the actuators and to the virtual environment system to calculate a position and orientation of the user within the virtual environment as a function of the length of the cables, and to control the actuators so as to constrain movement of the user interface as a function of interactions between the user and the virtual environment, to provide force feedback to the user.

6. The motion simulation system according to claim 5, wherein the user interface is a foot interface, the foot interface being adapted to support the feet of a user independently from one another.

7. The motion simulation system according to claim 6, further comprising a body harness connected to a trunk of the user, cables connected to the body harness, and actuators for relating the cables of the body harness to the frame so as to control a length of the cables associated with the body harness as a function of movements of the user in the foot interface, to maintain the user originally positioned within the frame.

8. The motion simulation system according to claim 6, further comprising at least one hand interface handled by the user, cables connected to the hand interface, and actuators for relating the cables of the hand interface to the frame, the cable tension controller controlling the actuators so as to constrain movement of the hand interface as a function of interactions between the user and the virtual environment to provide force feedback to the hands of the user.

9. The motion simulation system according to claim 5, wherein the virtual environment system produces sounds in accordance with interactions between the user and the virtual environment.

10. The motion simulation system according to claim 5, wherein the cable tension controller actuates the actuators to prevent motion in at least one of six degrees-of-freedom of the user interface.

11. The motion simulation system according to claim 6, wherein 6-axis sensors are provided on the foot interface so as to provide force information to the cable tension controller with respect to the feet of the user.

12. The motion simulation system according to claim 5, further comprising a cable interference calculator connected to the cable tension controller to detect interference between cables and to correct a position and orientation of the user interface within the virtual environment as calculated by the cable tension controller as a function of the length of the cables and of interference between cables.

13. The motion simulation system according to claim 5, wherein the cable tension controller controls the tension in the cables through the actuators during winding/unwinding of the cables as a function of movements of the user when providing force feedback.

14. The motion simulation apparatus according to claim 5, wherein the user interface has a hand interface handled by the user and a sword portion at an end of the hand interface, with the cables being connected to the hand interface, and actuators for relating the cables of the hand interface to the frame, the cable tension controller controlling the actuators so as to constrain movement of the hand interface as a function of interactions of the user manipulating the sword portion in the virtual environment to provide force feedback to the hands of the user.

15. A method for providing force feedback as a function of a virtual environment to a moving user provided with a user interface constrained by cables of adjustable length, comprising the steps of:
i) determining a position and orientation of the user interface;
ii) comparing the position and orientation of the user interface with respect to a virtual environment to determine interactions therebetween; and
iii) adjusting a length of the cables to provide force feedback to the user as a function of said interactions.

16. The method according to claim 15, wherein the user interface is a pair of foot supports such that the user has his/her feet suspended by the foot supports such that the step of iii) adjusting a length of the cables to provide force feedback to the user as a function of said interactions simulates locomotion of the user.

17. The method according to claim 16, wherein the step i) is performed by calculating the position and orientation of the feet of the user with the length of the cables.

18. The method according to claim 15, wherein the step iii) involves controlling a tension in the cables to provide the force feedback.

19. The method according to claim 15, further comprising a step of emitting sound as a function of interactions between the virtual environment and the user.

20. The method according to claim 16, wherein a body harness constrained by cables of adjustable length is secured to the trunk of the user and the step iii) comprises adjusting a length of the cables associated with the body harness to compensate for movement of the user so as to maintain the user originally positioned.

21. The method according to claim 16, wherein a body harness constrained by cables of adjustable length is secured to the trunk of the user and the step iii) comprises controlling a tension in the cables associated with the body harness to provide force feedback to the user.
